(19) United States
(12) Patent Application Publication
(10) Pub. No.: US 2016/0048748 A1
(43) Pub. Date: Feb. 18, 2016

(54) IMAGE PROCESSING APPARATUS, IMAGE PROCESSING SYSTEM, IMAGE PROCESSING METHOD, AND NON-TRANSITORY COMPUTER READABLE MEDIUM

(71) Applicant: FUJI XEROX CO., LTD., Tokyo (JP)

(72) Inventors: Shinji AKAHIRA, Kanagawa (JP); Yang LIU, Kanagawa (JP)

(21) Appl. No.: 14/612,919

(22) Filed: Feb. 3, 2015

(30) Foreign Application Priority Data
Aug. 14, 2014 (JP) 2014-165179

(51) Int. Cl. G06K 15/00; G06F 3/12; H04N 1/00; G06F 21/31

(52) U.S. Cl. CPC G06K 15/4095; G06F 21/31; G06F 3/1222; G06F 3/1238; G06F 3/1292; H04N 1/00307; H04N 1/00204; H04N 1/00854; H04N 2201/0094

(57) ABSTRACT

An image processing apparatus includes a first authentication unit, an accepting unit, and a second authentication unit. The first authentication unit obtains, from a terminal apparatus, information regarding a user who uses the image processing apparatus, and performs first authentication of the user by using the obtained information. The accepting unit accepts an instruction relating to image processing from the terminal apparatus in the first authentication. The second authentication unit accepts information regarding the user for whom the first authentication has been successfully completed, and performs second authentication in order to permit performing of the image processing based on the instruction accepted by the accepting unit.

### CROSS-REFERENCE TO RELATED APPLICATIONS

This application is based on and claims priority under 35 USC 119 from Japanese Patent Application No. 2014-165179 filed Aug. 14, 2014.

### BACKGROUND

### Technical Field

The present invention relates to an image processing apparatus, an image processing system, an image processing method, and a non-transitory computer readable medium.

### SUMMARY

According to an aspect of the invention, there is provided an image processing apparatus including a first authentication unit, an accepting unit, and a second authentication unit. The first authentication unit obtains, from a terminal apparatus, information regarding a user who uses the image processing apparatus, and performs first authentication of the user by using the obtained information. The accepting unit accepts an instruction relating to image processing from the terminal apparatus in the first authentication. The second authentication unit accepts information regarding the user for whom the first authentication has been successfully completed, and performs second authentication in order to permit performing of the image processing based on the instruction accepted by the accepting unit.

### BRIEF DESCRIPTION OF THE DRAWINGS

An exemplary embodiment of the present invention will be described in detail based on the following figures, wherein:

FIG. 1 is a diagram illustrating an example of an overall configuration of an image processing system according to an exemplary embodiment;

FIG. 2 is a diagram illustrating an example of a hardware configuration of an image processing apparatus according to the exemplary embodiment;

FIG. 3 is a block diagram illustrating an example of a functional configuration of the image processing apparatus according to the exemplary embodiment;

FIG. 4 is a diagram illustrating an example of a logged-in user list;

FIG. 5 is a diagram illustrating an example of a reservation list;

FIGS. 6A to 6C are diagrams illustrating examples of screens generated by a remote application and displayed on a display of a portable terminal;

FIG. 7 is a flowchart illustrating an example of a procedure in which the image processing apparatus performs a user authentication process;

FIG. 8 is a flowchart illustrating an example of a procedure in which the image processing apparatus grants a user a device use right;

FIG. 9 is a flowchart illustrating an example of a procedure in which the image processing apparatus processes a reservation for a device use right;

FIG. 10 is a flowchart illustrating an example of a procedure in which the image processing apparatus cancels a reservation for a device use right;

FIG. 11 is a flowchart illustrating another example of a procedure in which the image processing apparatus grants a user a device use right;

FIG. 12 is a flowchart illustrating another example of a procedure in which the image processing apparatus grants a user a device use right; and

FIG. 13 is a flowchart illustrating an example of a procedure in which the image processing apparatus cancels a device use right and user authentication.

### DETAILED DESCRIPTION

Hereinafter, an exemplary embodiment of the present invention will be described in detail with reference to the accompanying drawings.

### System Configuration

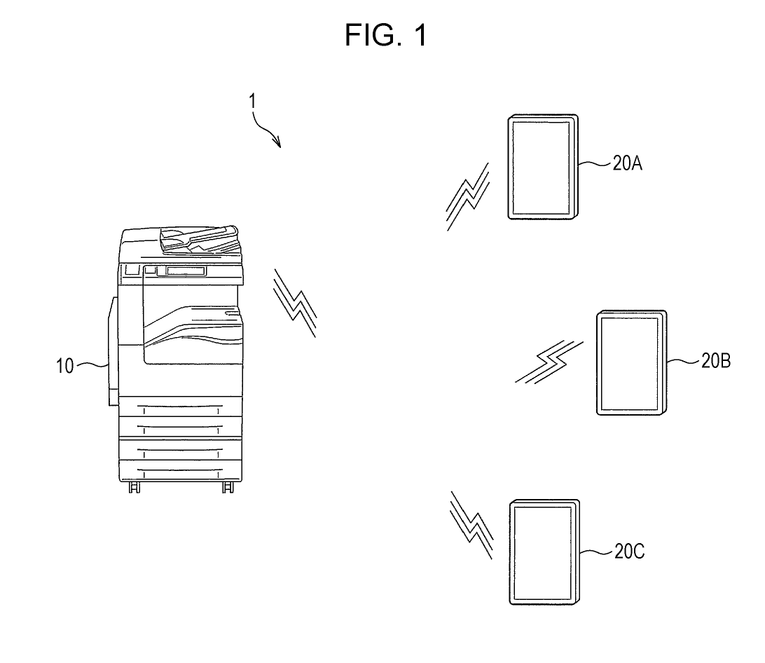

First, an overall configuration of an image processing system 1 according to an exemplary embodiment will be described. FIG. 1 is a diagram illustrating an example of an overall configuration of the image processing system 1 according to this exemplary embodiment. As illustrated in FIG. 1, the image processing system 1 includes an image processing apparatus 10, a portable terminal 20A, a portable terminal 20B, and a portable terminal 20C. It is assumed that the image processing apparatus 10 communicates with the portable terminal 20A, the portable terminal 20B, and the portable terminal 20C over a wireless network. Note that, while the portable terminal 20A, the portable terminal 20B, and the portable terminal 20C are illustrated in FIG. 1, these terminals are individually referred to as a portable terminal 20 or collectively referred to as portable terminals 20 in a case where the terminals need not be distinguished from one another. In the example illustrated in FIG. 1, three portable terminals 20 are illustrated, however, the number of the portable terminals 20 may be one, two, or three or more. In this exemplary embodiment, the portable terminal 20 is used as an example of a terminal apparatus.

The image processing apparatus 10 is an apparatus that performs a print process by forming an image on a recording medium, such as a sheet. As the image processing apparatus 10, an apparatus only having a print function may be used, or an apparatus further having other image processing functions, such as a scan function, a copy function, a facsimile function, and the like, in addition to a print function may be used.

Before the image processing apparatus 10 executes an image processing function, the image processing apparatus 10 first receives from the portable terminal 20 information used in authentication (hereinafter referred to as authentication information) regarding a user who operates the portable terminal 20 (user who is to use the image processing apparatus 10), and performs user authentication. The authentication information is a user identification (ID), a password, and the like, which is identification information used to identify the user, for example. After user authentication has been successfully completed, when the image processing apparatus 10 has further accepted, via an authentication device provided in the image processing apparatus 10, authentication information regarding the user for whom user authentication has been successfully completed, the image processing apparatus 10 grants the user a right to use the image processing apparatus 10 (hereinafter referred to as a device use right). That is, the user is not permitted to use the image processing apparatus 10 at the time when user authentication is successfully completed but is permitted to use the image processing apparatus 10 after further acquiring a device use right, and an image processing function is executed.

Note that authentication information input via the authentication device might not be the same as that used in user authentication, and may be any information, such as a user ID only, for example, as long as the user is able to be identified by the information. Both processes, that is, user authentication and grant of a device use right, may be performed by a user operating the image processing apparatus 10, which will be described in detail below.

The portable terminal 20 is a portable-type terminal apparatus used to execute various functions of the image processing apparatus 10, and is a smartphone, a tablet personal computer (PC), a note PC, or the like, for example. The portable terminal 20 includes application software (hereinafter referred to as a remote application) for making the image processing apparatus 10 execute various functions, such as a print function. When a user has input authentication information using the remote application and user authentication has been successfully completed, the user performs operations for presetting color, ratio, or the like to be used at the time of output, transmitting a print job, giving an instruction for performing copying or printing, and the like by using the remote application. A print job includes image data to be used in printing and a control command that includes settings to be used in a print process, and is data that is assumed to be a unit of a print process which is performed by the image processing apparatus 10.

When the remote application has been activated in response to an operation performed by a user, the portable terminal 20 first accepts authentication information regarding the user which has been input by the user. When the authentication information has been input by the user, the portable terminal 20 transmits the input authentication information to the image processing apparatus 10. On the basis of the transmitted authentication information, the image processing apparatus 10 performs user authentication. In a case where user authentication has been successfully completed, the portable terminal 20 enters a mode in which an operation for performing presetting relating to output by the image processing apparatus 10, an operation for transmitting a print job to the image processing apparatus 10, and the like may be accepted. However, at this point in time, no device use right has been granted to the user, and therefore, the portable terminal 20 does not accept an operation for giving an instruction for performing copying or an operation for giving an instruction for performing printing. Thereafter, when a device use right has been granted to the user, the portable terminal 20 enters a mode in which an operation for giving an instruction for performing copying or printing to the image processing apparatus 10 may be accepted. In a case where a user makes the image processing apparatus 10 execute an image processing function by using the portable terminal 20, the user may use a Web browser instead of the remote application.

As described above, a user is permitted to use the image processing apparatus 10 when user authentication has been successfully completed and the user has acquired a device use right. Here, it is assumed that a device use right is not granted to plural users simultaneously. However, in a case where a user desires to use the image processing apparatus 10 and if a device use right has already been granted to another user, the user may make a reservation for a device use right. In a case where plural users have made reservations for a device use right, a device use right is granted to each user in the order of reservation.

### Hardware Configuration of Image Processing Apparatus 10

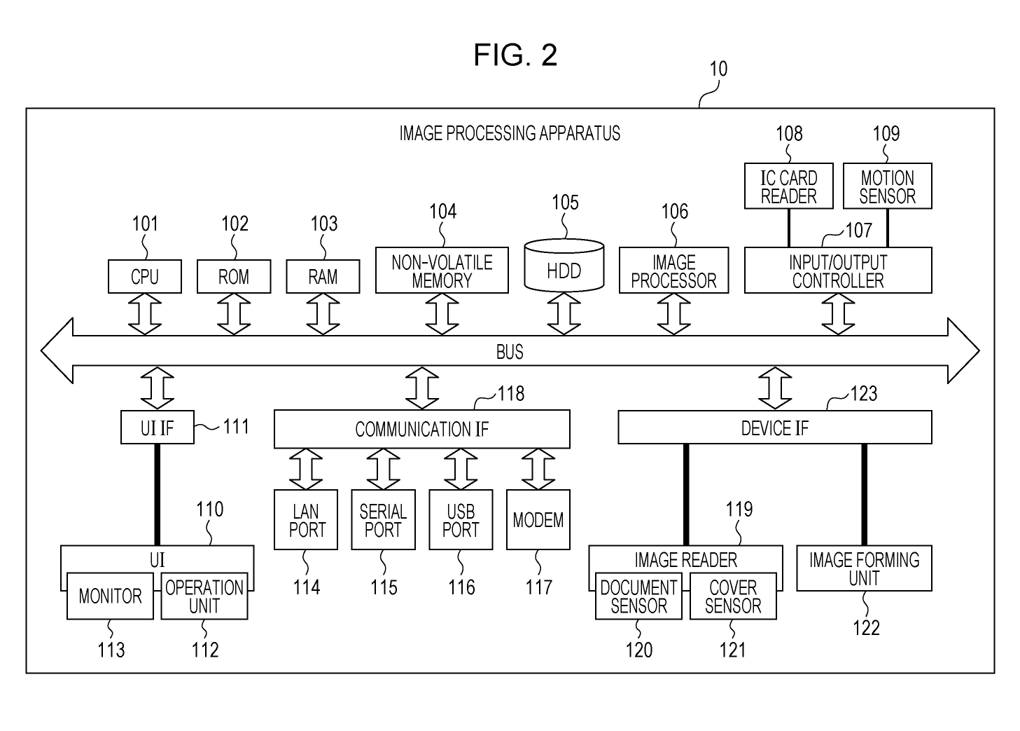

Next, a hardware configuration of the image processing apparatus 10 will be described. FIG. 2 is a diagram illustrating an example of a hardware configuration of the image processing apparatus 10 according to this exemplary embodiment.

A central processing unit (CPU) 101 loads various programs stored in a read-only memory (ROM) 102 or the like into a random access memory (RAM) 103 and executes the programs to thereby perform overall control of the image processing apparatus 10 and implement various functions of the image processing apparatus 10.

The ROM 102 is a memory that stores various programs executed by the CPU 101, predetermined fixed data, and the like. The ROM 102 may be configured so as to be rewritable by using a flash memory, for example.

The RAM 103 is a memory used as a work memory of the CPU 101, for example. The RAM 103 functions as a system memory when the programs run, or functions as a page memory when image processing is performed.

A non-volatile memory 104 is a memory capable of retaining information stored therein without power feeding and stores parameters used in image adjustment and various types of history data.

A hard disk drive (HDD) 105 is a magnetic disk device, for example, and stores image data read by an image reader 119, image data used in image formation performed by an image forming unit 122, and the like.

An image processor 106 performs processes on image data, such as compression/decompression processes on image data.

An input/output controller 107 controls an integrated circuit (IC) card reader 108 and a motion sensor 109. The IC card reader 108 reads an IC card into which an IC is integrated for recording information and calculation, and obtains information recorded in the IC card. The motion sensor 109 is a sensor that detects people or objects being present and, when a person or an object moves in the detection area, detects the motion.

The functional units, that is, the CPU 101, the ROM 102, the RAM 103, the non-volatile memory 104, the HDD 105, the image processor 106, and the input/output controller 107, are connected to one another via a bus.

A user interface (UI) 110 is connected to the bus via a UI interface (IF) 111. The UI 110 is formed of buttons, such as a start key, a stop key, a numeric keypad, and the like, and includes an operation unit 112 that is operated by a user. The UI 110 further includes a monitor 113 that is formed of a liquid crystal monitor and displays various images. In a case where the monitor 113 is configured by using a touch panel system, the monitor 113 also functions as the operation unit 112.

A local area network (LAN) port 114 is an interface for externally inputting/outputting data and is based on a standard, such as 10Base-T, 100Base-T, or the like, for example. The LAN port 114 also functions as a wireless communication interface.

A serial port 115 is an interface for connecting with an external peripheral device.

A Universal Serial Bus (USB) port 116 is an interface for connecting with a peripheral device using a USB cable and is based on a standard, such as USB 1.1, USB 2.0, or the like, for example.

A modem 117 is a controller that connects a facsimile unit and the like to a public line, and is able to provide various facsimile functions.

The LAN port 114, the serial port 115, the USB port 116, and the modem 117 are connected to the bus via a communication IF 118.

The image reader 119 reads an image recorded on a sheet or the like. The image reader 119 is a scanner, for example, and a device based on a charge coupled device (CCD) system or a contact image sensor (CIS) system may be used as the image reader 119. A CCD system is a system in which light reflected from a document that is irradiated with light emitted from a light source is concentrated by a lens and are received by a CCD. A CIS system is a system in which light reflected from a document that is irradiated with sequential emission of light from a light-emitting diode (LED) light source is received by a CIS. The image reader 119 includes an automatic document feeder that reads pages while automatically feeding the pages, and further includes a document sensor 120 that detects a document having been loaded in the automatic document feeder. The image reader 119 further includes a transparent plate on which a document is placed in order to read the document, and further includes a cover sensor 121 that detects a cover covering the transparent plate having been opened.

The image forming unit 122 forms an image on a sheet or the like, which is an example of a recording medium. The image forming unit 122 is a printer, for example, and a printer based on an electrophotographic system in which toner applied to a photoreceptor is transferred to a sheet to thereby form an image or a printer based on an ink-jet system in which ink is jetted on a recording medium to thereby form an image may be used as the image forming unit 122.

The image reader 119 and the image forming unit 122 are connected to the bus via a device IF 123.

Note that FIG. 2 merely illustrates an example of the hardware configuration of the image processing apparatus 10 to which this exemplary embodiment is applicable, and the illustrated configuration is not the only one that implements this exemplary embodiment.

### Functional Configuration of Image Processing Apparatus 10

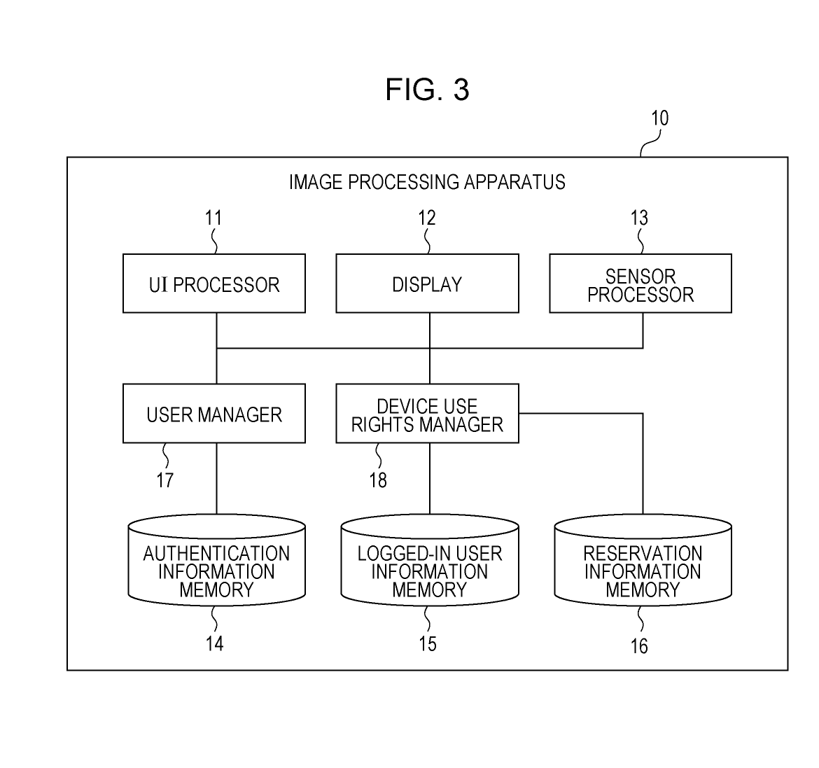

Next, a functional configuration of the image processing apparatus 10 will be described. FIG. 3 is a block diagram illustrating an example of a functional configuration of the image processing apparatus 10 according to this exemplary embodiment.

The image processing apparatus 10 includes a UI processor 11 that accepts operation input from a user, a display 12 that displays various images, and a sensor processor 13 that accepts detection by various sensors. The image processing apparatus 10 further includes an authentication information memory 14 that stores authentication information used in user authentication, a logged-in user information memory 15 that stores information regarding users for whom user authentication has been successfully completed, and a reservation information memory 16 that stores information regarding users who have made reservations for a device use right. The image processing apparatus 10 further includes a user manager 17 that performs user authentication on the basis of authentication information received from the portable terminal 20 and a device use rights manager 18 that grants a user a device use right.

The UI processor 11 that is an example of an accepting unit accepts operation input from a user. The UI processor 11 accepts an instruction for performing presetting relating to image processing, an instruction for performing image processing, and the like from the portable terminal 20. The UI processor 11 accepts operation input to the image processing apparatus 10 when a user presses the buttons of the operation unit 112, for example. The UI processor 11 accepts authentication information input into the image processing apparatus 10 by a user via the authentication device, for example. Here, the authentication device is the IC card reader 108 or the operation unit 112 illustrated in FIG. 2, for example.

In a case where the IC card reader 108 functions as the authentication device, for example, when a user holds an IC card, in which authentication information regarding the user is recorded, over the IC card reader 108, the authentication information recorded in the IC card is input in a non-contact manner using near field wireless communication (for example, near field-type wireless communication or near field communication (NFC)). In a case where the operation unit 112 functions as the authentication device, for example, when a user presses the buttons of the operation unit 112, authentication information is input. In a case where the monitor 113 is configured by using a touch panel system, when a user presses buttons or the like displayed on the monitor 113, authentication information is input. A user may input authentication information by using near field wireless communication (for example, Bluetooth (registered trademark)) provided by the portable terminal 20.

The display 12 displays various images to a user.

The sensor processor 13 accepts detection by various sensors (the motion sensor 109, the document sensor 120, and the cover sensor 121). For example, when a document having been loaded has been detected by the document sensor 120, the sensor processor 13 accepts the detection.

The authentication information memory 14 stores a list in which authentication information used in user authentication has been registered (hereinafter referred to as authentication information list). In the authentication information list, information regarding users for whom user authentication is expected to be successfully completed, for example, has been registered in advance by the administrator of the image processing system 1 on a user-by-user basis. For example, information including a user ID (user name), a password, operations, such as copying, printing, and the like, for which the user is authorized (that is, operations available to the user) has been registered. The authentication information list is referred to when the user manager 17 performs user authentication. While it is assumed, in this exemplary embodiment, that the authentication information memory 14 stores the authentication information list, the authentication information list may be stored in an external server (for example, a Lightweight Directory Access Protocol (LDAP) server).

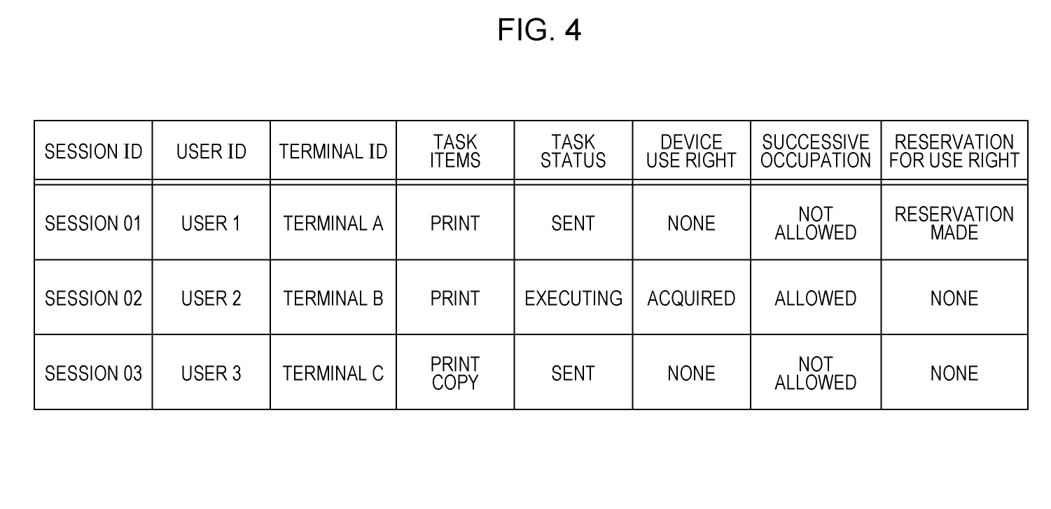

The logged-in user information memory 15 stores a list (hereinafter referred to as a logged-in user list) in which information regarding users (hereinafter referred to as logged-in users), for whom user authentication has been successfully completed by inputting authentication information from the portable terminal 20, has been registered. In the logged-in user list, for each user for whom user authentication has been successfully completed, information has been registered as to whether or not the user has been granted a device use right, whether or not the user has made a reservation for a device use right, and so on, for example. As described above, a user for whom user authentication has been successfully completed by an operation on the portable terminal 20 is managed as a logged-in user who is currently logged in to the image processing apparatus 10. The logged-in user list will be described in detail with reference to FIG. 4.

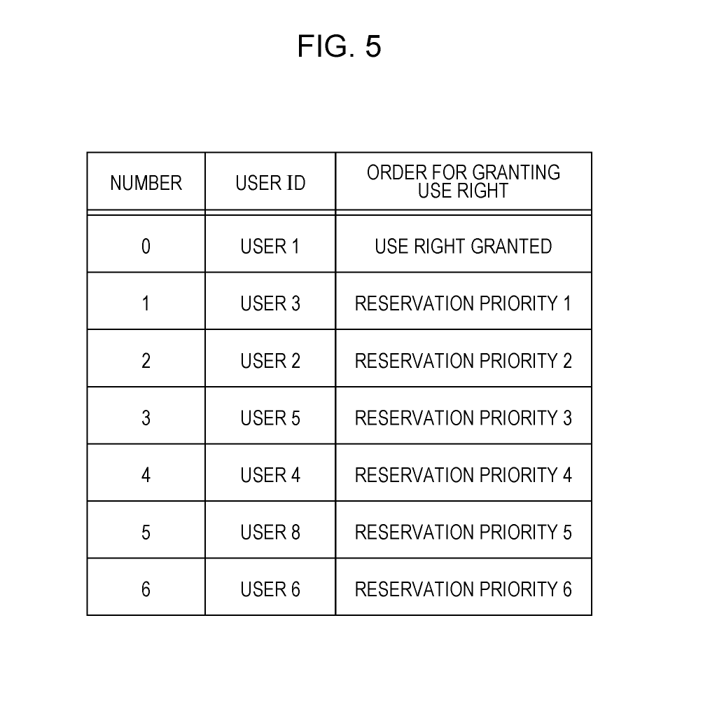

The reservation information memory 16 stores a list (hereinafter referred to as a reservation list) in which, for users who have performed operations for making reservations for a device use right from the portable terminals 20, the order in which a device use right is to be granted has been registered. The reservation list will be described in detail with reference to FIG. 5.

The user manager 17 that serves as a first authentication unit and a display controller, for example, performs, when the user manager 17 has received authentication information from the portable terminal 20, user authentication on the basis of the received authentication information. When the user manager 17 has received authentication information from the portable terminal 20, the user manager 17 performs user authentication for the user regardless of whether or not a device use right has already been granted to any user. In user authentication, the user manager 17 refers to the authentication information list stored in the authentication information memory 14 and determines whether or not the authentication information received from the portable terminal 20 has been registered in the authentication information list.

If the authentication information has been registered in the authentication information list, the user manager 17 determines that user authentication is successful and allows the image processing apparatus 10 to perform operations for which the user is authorized. However, no device use right has been granted to the user at the time of successful user authentication, which will be described below.

In a case where another user for whom user authentication has not yet been successfully completed is present in the vicinity of the image processing apparatus 10 and authentication information regarding the user is input into the image processing apparatus 10 via the authentication device, the user manager 17 also performs user authentication by referring to the authentication information list. In this exemplary embodiment, as the first authentication, the process is employed in which user authentication is performed on the basis of authentication information, for example.

The device use rights manager 18 that serves as a second authentication unit, a reservation unit, and the display controller, for example, grants a user a device use right and permits the user to execute image processing functions. When the UI processor 11 has accepted authentication information via the authentication device (that is, when authentication information has been input into the image processing apparatus 10 via the authentication device), the device use rights manager 18 determines whether or not a device use right has been already granted to any user. If a device use right has already been granted, the device use rights manager 18 displays on the display 12 that a device use right has already been granted to another user.

On the other hand, if a device use right has not yet been granted, the device use rights manager 18 refers to the logged-in user list and determines whether or not a logged-in user that matches the user corresponding to the accepted authentication information is present. If a logged-in user that matches the user is present, the device use rights manager 18 grants the logged-in user (that is, the user corresponding to the accepted authentication information) a device use right, and permits the logged-in user to execute an image processing function for which an instruction has been given from the portable terminal 20 by an operation performed by the logged-in user. If a logged-in user that matches the user is not present, that is, if authentication information regarding the user for whom user authentication has not yet been successfully completed has been input into the image processing apparatus 10 via the authentication device, user authentication is performed by the user manager 17 as described above. If user authentication is successful, the device use rights manager 18 grants the user a device use right and permits the image processing apparatus 10 to execute an image processing function for which an instruction has been given. In this exemplary embodiment, as the second authentication, the process is employed in which a device use right is granted after authentication information has been accepted, for example.

The device use rights manager 18 further processes a reservation for a device use right. When the device use rights manager 18 has received a notification of a reservation made for a device use right from the portable terminal 20, the device use rights manager 18 registers information regarding the user who has made a reservation for a device use right in the reservation list on the basis of the received notification. When the device use rights manager 18 has received a notification of cancellation of a reservation for a device use right from the portable terminal 20, the device use rights manager 18 deletes information regarding the user who has cancelled the reservation for a device use right from the reservation list on the basis of the received notification.

The UI processor 11, the sensor processor 13, the user manager 17, and the device use rights manager 18 are implemented by the CPU 101 in the hardware configuration illustrated in FIG. 2, for example. More specifically, a program that implements the functions of the image processing apparatus 10 is stored in the ROM 102, and the CPU 101 loads the program into the RAM 103 and executes the program to thereby implement the functions of the UI processor 11, the sensor processor 13, the user manager 17, and the device use rights manager 18. The display 12 is implemented by the monitor 113, for example. The authentication information memory 14, the logged-in user information memory 15, and the reservation information memory 16 are implemented by the non-volatile memory 104 or the HDD 105, for example.

Note that the program executed by the CPU 101 may be stored in a computer readable recording medium, such as a magnetic recording medium (a magnetic tape, a magnetic disk, or the like), an optical recording medium (an optical disk or the like), a magneto-optical recording medium, or a semiconductor memory and may be provided from such a recording medium. The program may be downloaded to the image processing apparatus 10 via communication, such as the Internet.

### Description of Logged-in User List

Next, the logged-in user list stored in the logged-in user information memory 15 will be described. FIG. 4 is a diagram illustrating an example of the logged-in user list.

An item “User ID” represents identification information given to each user in order to identify the user. An item “Terminal ID” represents identification information given to each portable terminal 20 in order to identify the portable terminal 20. Note that, as information for identifying each portable terminal 20, a Media Access Control (MAC) address or the like of the portable terminal 20 may be used, for example, instead of a terminal ID. An item “Session ID” represents identification information given to each connection between the image processing apparatus 10 and the portable terminal 20.

An item “Task Items” represents image processing functions for which each user is authorized. An item “Task Status” represents the execution status of the image processing functions. An item “Device Use Right” represents whether or not each user has already acquired a device use right. An item “Successive Occupation” represents whether or not a successively occupying process is allowed in which each user successively prints plural print jobs. In a case where plural print jobs of a user who has acquired a device use right have accumulated in the image processing apparatus 10, the user may be “allowed” to successively occupy the image processing apparatus 10. An item “Reservation for Use Right” represents whether or not each user has already made a reservation for a device use right.

In the illustrated example, for three users respectively identified by user IDs “User 1”, “User 2”, and “User 3”, user authentication has been successfully completed, and the users operate the portable terminals 20 respectively identified by terminal IDs “Terminal A”, “Terminal B”, and “Terminal C”. Session IDs given to connections between the image processing apparatus 10 and the portable terminals 20 are “session 01”, “session 02”, and “session 03”. As the task items, an item “Print” that represent a print function and an item “Copy” that represent a copy function are registered. As the task status of the task items, a status “Sent” and a status “Executing” are registered. For example, the status of a print function relating to “User 1” is “Sent”, which indicates that a print job generated by an operation of “Terminal A” has already been sent (transmitted) to the image processing apparatus 10. For example, the status of a print function relating to “User 2” is “Executing”, which indicates that the print function is being executed by the image processing apparatus 10.

Regarding the device use right, the user “User 2” is indicated as “Acquired”, which indicates that the user has already acquired a device use right. The other users have not acquired a device use right, and therefore, are registered as “None”. Successive occupation by the user “User 2” is “Allowed”, and therefore, before a print process on a print job is completed, an inquiry about whether or not the next print job is to be successively printed is made to the user “User 2”. If the user decides to successively print the next print job, a print process on the next print job is performed. Regarding the reservation of a device use right, the user “User 1” is indicated as “Reservation made”, which indicates that the user has performed an operation for making a reservation for a device use right. The other users have not made reservations for a device use right, and therefore, are registered as “None”.

### Description of Reservation List

Next, the reservation list stored in the reservation information memory 16 will be described. FIG. 5 is a diagram illustrating an example of the reservation list.

An item “Number” represents a number given to each user who has been registered in the reservation list. A number is given to each user who has made a reservation for a device use right in the order of reservation. An item “User ID” represents identification information (user ID) of each user who has been registered in the reservation list. For example, the item “User ID” represents a user ID of a user who has pressed a button for enabling a reservation function (hereinafter referred to as a reservation button) displayed on a display of the portable terminal 20 and has performed an operation for making a reservation for a device use right.

An item “Order of Granting Use Right” represents the order for granting a device use right. In this exemplary embodiment, the reservation button is used as an example of an operation accepting section. In the illustrated example, regarding the user “User 1”, who has been given a number “0”, “Use right granted” is registered as the order for granting a use right, which indicates that the user “User 1” currently retains a device use right. Regarding the user “User 2”, who has been given a number “2”, “Reservation Priority 2” is recorded as the order for granting a use right, which indicates that the user “User 2” is granted a device use right second, and therefore, the user “User 2” is granted a device use right after a user given a number “1” (the user “User 3” in the example of FIG. 5) has been granted a device use right.

### Examples of Screens Displayed on Display of Portable Terminal 20

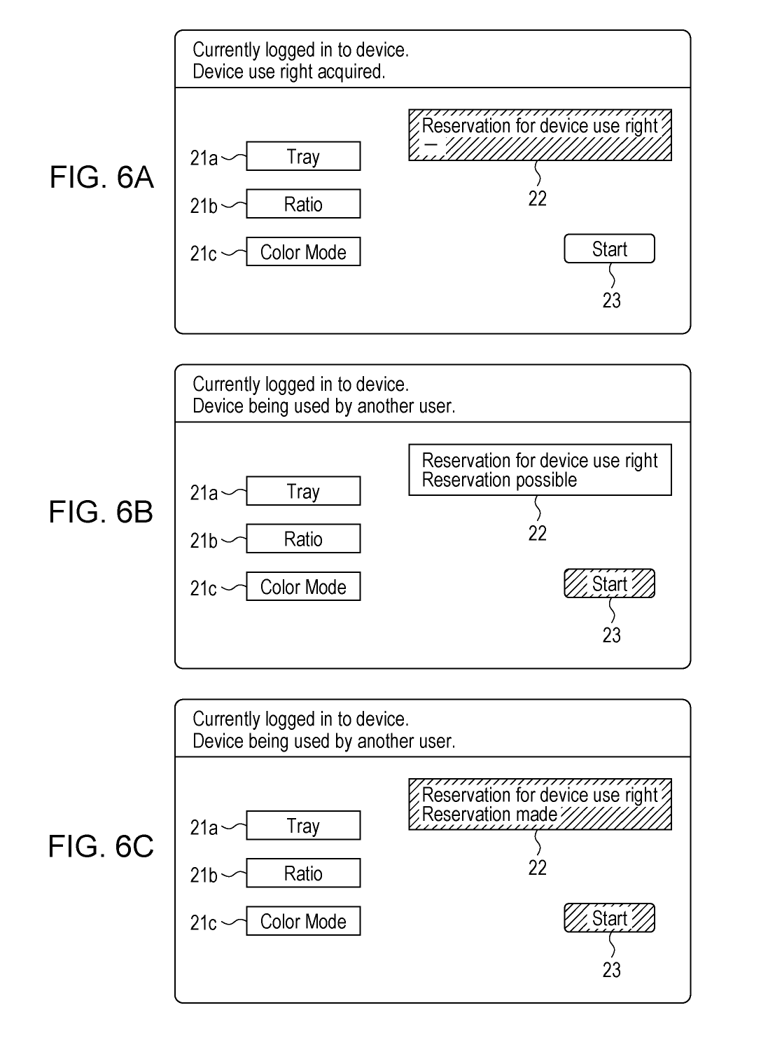

Next, screens generated by the remote application and displayed on the display of the portable terminal 20 will be described. FIGS. 6A to 6C are diagrams illustrating examples of screens generated by the remote application and displayed on the display of the portable terminal 20. In FIGS. 6A to 6C, for a user who operates the portable terminal 20, user authentication has been successfully completed, and the user is a logged-in user who is currently logged in to the image processing apparatus 10. Here, when the user has activated the remote application on the portable terminal 20 and has performed an operation for user authentication, and if user authentication is successful, a menu listing functions for which the user is authorized is displayed on the screen. When the user has selected a copy function among the functions for which the user is authorized, for example, screens illustrated in FIGS. 6A to 6C are displayed as screens for performing presetting for the copy function or executing the copy function.

FIG. 6A is an example of a screen generated by the remote application and displayed on the display of the portable terminal 20 that a user who has acquired a device use right operates. As illustrated in FIG. 6A, in an upper portion of the screen, messages are displayed indicating that the user is currently logged in to the image processing apparatus 10, which is indicated as “device” in the screens illustrated in FIGS. 6A to 6C, that is, user authentication for the user has been successfully completed, and that the user has already acquired a device use right. A preset button 21a is a button for selecting a feeder unit, which is indicated as “tray” in the screens illustrated in FIGS. 6A to 6C, used for feeding sheets. A preset button 21b is a button for setting the ratio by which an image is enlarged (or reduced) at the time of output. A preset button 21c is a button for selecting a color mode, that is, monochrome output or color output, for example. The preset button 21c may be configured to function as a button for specifying the number of copies to be output.

A reservation button 22 is a button used for making a reservation for a device use right. However, in the example illustrated in FIG. 6A, the user has already acquired a device use right and does not further make a reservation for a device use right. Therefore, the reservation button 22 is in a non-selectable state. In a non-selectable state, the reservation button 22 is displayed in gray, which corresponds to a shaded portion in the example illustrated in FIG. 6A, for example, and, even if the user selects the reservation button 22, the portable terminal 20 does not perform a process for accepting the reservation. A process performing button 23 is a button for giving an instruction, from the portable terminal 20 to the image processing apparatus 10, for performing image processing. In the example illustrated in FIG. 6A, the user has already acquired a device use right, and therefore, the process performing button 23 is in a state where a selection operation may be accepted. That is, when the user has selected the process performing button 23, the portable terminal 20 gives an instruction for performing image processing to the image processing apparatus 10.

Next, FIG. 6B is a diagram illustrating an example of a screen generated by the remote application and displayed on the display of the portable terminal 20 that a user who is allowed to make a reservation for a device use right operates. As illustrated in FIG. 6B, in an upper portion of the screen, messages are displayed indicating that the user is currently logged in to the image processing apparatus 10 and that the image processing apparatus 10 is being used by another user. The user is allowed to make a reservation for a device use right, and the reservation button 22 is in the state where a selection operation may be accepted. In the example illustrated in FIG. 6B, a message “Reservation possible” is displayed on the reservation button 22, which indicates that it is possible to make a reservation for a device use right. On the other hand, the user has not acquired a device use right, and therefore, an instruction for performing image processing is not given and the process performing button 23 is in the non-selectable state.

FIG. 6C is a diagram illustrating an example of a screen generated by the remote application and displayed on the display of the portable terminal 20 that a user who has made a reservation for a device use right operates. As illustrated in FIG. 6C, in an upper portion of the screen, messages are displayed indicating that the user is currently logged in to the image processing apparatus 10 and that the image processing apparatus 10 is being used by another user. The user has already made a reservation for a device use right, and therefore, the reservation button 22 is in the non-selectable state. In the example illustrated in FIG. 6C, a message “Reservation made” is displayed on the reservation button 22, which indicates that a reservation for a device use right has been made. On the other hand, the user has not acquired a device use right, and therefore, an instruction for performing image processing is not given, and the process performing button 23 is in the non-selectable state.

### Procedure of Process for User Authentication

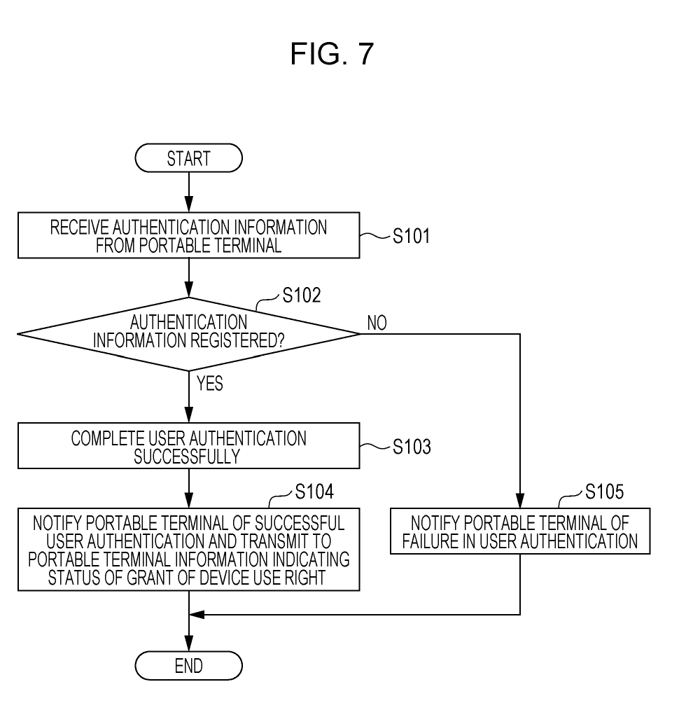

Next, a procedure of a user authentication process will be described. FIG. 7 is a flowchart illustrating an example of a procedure in which the image processing apparatus 10 performs a user authentication process. Description of the procedure illustrated in FIG. 7 will be given while assuming that a user performs an operation for user authentication by using the portable terminal 20A.

First, when the user has activated the remote application on the portable terminal 20A and has input authentication information, the authentication information is transmitted to the image processing apparatus 10 from the portable terminal 20A. The user manager 17 receives the authentication information (step S101). Next, the user manager 17 refers to the authentication information list stored in the authentication information memory 14 and determines whether or not the received authentication information has been registered in the authentication information list (step S102). If the authentication information has been registered (Yes in step S102), the user manager 17 successfully completes user authentication (step S103). Here, in a case where the user, for whom user authentication has been successfully completed, has been registered in the authentication information list such that the user is authorized to perform copying and scanning, for example, the user is allowed to operate the image processing apparatus 10 to perform copying and scanning. However, at this point in time, the user is not granted a device use right. In a case where a device use right has already been granted to another user, the user is allowed to make a reservation for a device use right. On the other hand, even if user authentication has been successfully completed, the user is not allowed to make a reservation for a device use right in order to perform an operation for which the user is not authorized.

Next, the user manager 17 notifies the portable terminal 20A, which is the source that has transmitted the authentication information, of successful user authentication and transmits to the portable terminal 20A information indicating the status of grant of a device use right (step S104), and the process flow ends. Here, user authentication has been successfully completed, and therefore, the user is allowed to operate the image processing apparatus 10 for a function for which the user is authorized via the portable terminal 20A. For example, if the user is authorized to perform printing, the portable terminal 20A enters a mode in which presetting for printing and transmission of a print job may be accepted. A print job that has been transmitted accumulates in the image processing apparatus 10. For example, if the user is authorized to perform copying, the portable terminal 20A enters a mode in which presetting of the ratio, the color mode, the number of copies, and the like to be used at the time of copying may be accepted.

However, the user has not yet been granted a device use right, and therefore, the portable terminal 20A has not yet accept an operation for giving an instruction for performing a print process on a print job that has been transmitted or an operation for giving an instruction for performing copying based on the details that have been preset. Here, information that the user has input on the screen of the portable terminal 20A, such as “copy, color, three copies (that is, three copies are to be output in color by a copy function)”, may accumulate in the image processing apparatus 10. Alternatively, the information may temporarily accumulate in the portable terminal 20 and may be transmitted to the image processing apparatus 10 after the user has acquired a device use right.

The information indicating the status of grant of a device use right, which is transmitted in step S104, is information indicating that a device use right has been granted to another user or that a device use right has not yet been granted to any user, for example. If a device use right has been granted to another user, for example, the reservation function for a device use right is enabled, and the reservation button enters the state where a selection operation may be accepted on the portable terminal 20A, as illustrated in FIG. 6B. More specifically, when the user manager 17 has transmitted information indicating the status of grant of a device use right to the portable terminal 20A, display on the display of the portable terminal 20A is controlled, and the reservation button enters a selectable state. On the other hand, in a case where a device use right has not yet been granted to any user, for example, the reservation button remains in the non-selectable state on the portable terminal 20A. In this case, a message prompting a user to acquire a device use right may be displayed.

In step S102, if the authentication information has not been registered (No in step S102), the user manager 17 notifies the portable terminal 20A, which is the source that has transmitted the authentication information, of failure in user authentication (step S105), and the process flow ends. Here, a message, such as “No matching user present”, for example, is displayed on the display of the portable terminal 20A, and the user is notified of failure in the authentication.

As described above, when a user who is to use the image processing apparatus 10 has input authentication information on the portable terminal 20, the authentication information is transmitted to the image processing apparatus 10, and a user authentication process is performed. If user authentication is successful, the user is allowed to perform an operations relating to a function for which the user is authorized, and therefore, an operation for transmitting a print job from the portable terminal 20 and accumulating the print job in the image processing apparatus 10, for example, is performed. It is assumed that a process for performing presetting relating to output or a process for transmitting a print job is performed even if a device use right has been granted to another user.

### Procedure for Granting Device Use Right

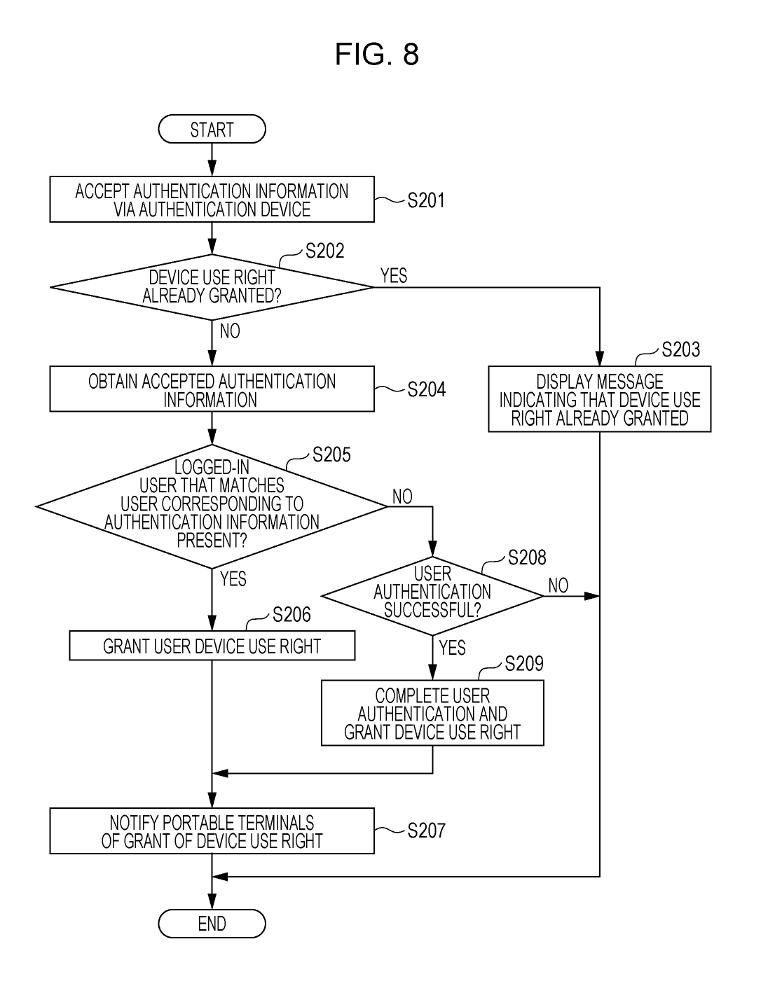

Next, a procedure for granting a device use right will be described. FIG. 8 is a flowchart illustrating an example of a procedure in which the image processing apparatus 10 grants a user a device use right. Description of the procedure illustrated in FIG. 8 will be given while assuming that a user operates the portable terminal 20A similarly to FIG. 7.

First, when the user, who is present in the vicinity of the image processing apparatus 10, has input authentication information via the authentication device provided in the image processing apparatus 10, the UI processor 11 accepts the authentication information (step S201). Next, when the UI processor 11 has accepted the authentication information, the device use rights manager 18 determines whether or not a device use right has already been granted to any user (step S202). Here, the device use rights manager 18 refers to the logged-in user list stored in the logged-in user information memory 15 and determines whether or not a device use right has already been granted.

If a device use right has already been granted (Yes in step S202), the device use rights manager 18 displays on the display 12 a message indicating that a device use right has already been granted to another user (step S203), and the process flow ends. Here, a message, such as “User 1 is using the device”, for example, is displayed on the display 12 to thereby notify the user who has input the authentication information of the fact that a device use right has already been granted to the other user.

On the other hand, if a device use right has not yet been granted (No in step S202), the device use rights manager 18 obtains the authentication information accepted by the UI processor 11 (step S204). The device use rights manager 18 refers to the logged-in user list and determines whether or not a logged-in user that matches the user corresponding to the obtained authentication information is present, that is, whether or not user authentication for the user corresponding to the obtained authentication information has been successfully completed (step S205).

If a logged-in user that matches the user is present (Yes in step S205), the device use rights manager 18 grants the logged-in user, that is, the user who has input the authentication information in step S201, a device use right (step S206). Here, the device use rights manager 18 records the fact that a device use right has been granted to the user and updates the logged-in user list. The device use rights manager 18 notifies the portable terminals 20 that logged-in users operate of grant of a device use right (step S207).

Here, the portable terminal 20A (that is, the portable terminal 20 used by the user to which a device use right has been granted) enters a mode in which an operation for giving an instruction for performing image processing, such as a print process on a print job, may be accepted in response to the notification of grant of a device use right. Specifically, on the portable terminal 20A, the process performing button 23 displayed on the display enters the state where a selection operation may be accepted, as illustrated in FIG. 6A, for example. On the other hand, the reservation function for a device use right is disabled because the user has acquired a device use right, and the reservation button enters the non-selectable state.

On the portable terminals 20 other than the portable terminal 20A, the reservation function for a device use right is enabled in response to the notification of grant of a device use right to the user who operates the portable terminal 20A, and the reservation button enters the state where a selection operation may be accepted, as illustrated in FIG. 6B, for example. More specifically, when the device use rights manager 18 notifies the portable terminals 20 of grant of a device use right, display on the displays of the portable terminals 20 is controlled, and the reservation buttons enter the selectable state. However, in a case where the reservation function has already been enabled in step S104, the reservation button remains in the state where a selection operation may be accepted. The process performing button 23 remains in the non-selectable state. On the display of the portable terminal 20A, a message indicating that the image processing apparatus 10 is being used by another user is displayed, and the process flow ends.

In step S205, if a logged-in user that matches the user is not present (No in step S205), user authentication for the user has not yet been successfully completed. That is, authentication information is to be input into the image processing apparatus 10 instead of being input into the portable terminal 20A, and user authentication is performed thereafter. More specifically, in a case of negative determination (No) in step S205, the user manager 17 determines whether or not user authentication is successful (step S208). Here, the user manager 17 refers to the authentication information list and, if the authentication information has been registered in the authentication information list, successfully completes user authentication similarly to steps S102 and S103 in FIG. 7. The user manager 17 checks the authority of the user by using the authentication information list and allows the user to only perform an operation for which the user is authorized.

If user authentication is successful (Yes in step S208), the user manager 17 successfully completes user authentication, the device use rights manager 18 grants the user for whom user authentication is successful a device use right (step S209), and the process flow proceeds to step S207. The user for whom user authentication is successful may press the buttons or the like on the operation unit 112 to thereby perform image processing. On the other hand, if user authentication is not successful (No in step S208), the process flow ends. If user authentication is not successful, a message or the like that prompts the user to input authentication information again may be displayed on the display 12, for example.

As described above, when user authentication has been performed by an operation of the portable terminal 20 and thereafter authentication information regarding the user for whom user authentication is successful has been input into the image processing apparatus 10 via the authentication device, the image processing apparatus 10 grants the user a device use right. However, in a case where a user for whom user authentication has not been successfully completed via the portable terminal 20 in advance inputs authentication information via the authentication device, a process for user authentication and a process for grant of a device use right are performed.

### Procedure for Making Reservation for Device Use Right

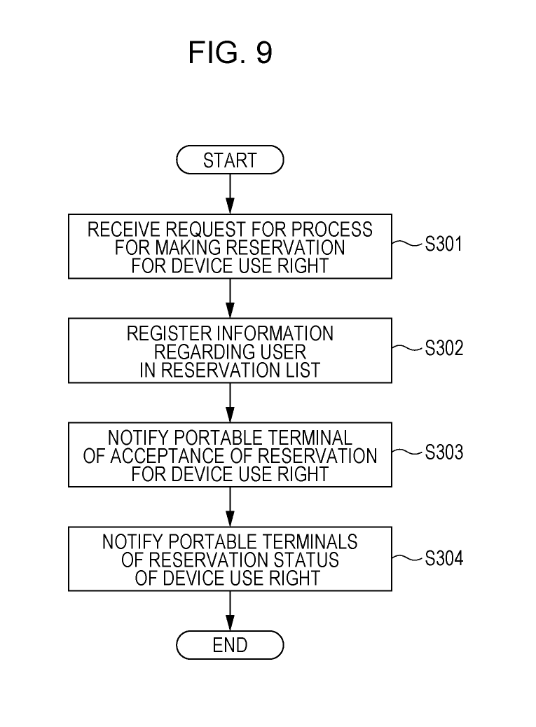

Next, a procedure for making a reservation for a device use right will be described. FIG. 9 is a flowchart illustrating an example of a procedure in which the image processing apparatus 10 processes a reservation for a device use right. In the procedure illustrated in FIG. 9, it is assumed that a user (the user having the user ID “User 1”, simply referred to as “User 1” in the description of the example illustrated in FIG. 9) performs an operation for making a reservation for a device use right by using the portable terminal 20A. It is further assumed that another user (the user having the user ID “User 2”, simply referred to as “User 2” in the description of the example illustrated in FIG. 9) has already acquired a device use right by operating the portable terminal 20B. Here, on the display of the portable terminal 20A of User 1, a message indicating that the image processing apparatus 10 is being used by the other user (User 2) is displayed, as illustrated in FIG. 6B, for example.

First, when User 1 has selected the reservation button displayed on the display of the portable terminal 20A, a request for a process for making a reservation for a device use right is transmitted to the image processing apparatus 10 from the portable terminal 20A. The device use rights manager 18 receives the request for a process for making a reservation for a device use right (step S301). Next, the device use rights manager 18 registers information regarding User 1 who has made a reservation for a device use right in the reservation list on the basis of the received request for a process (step S302).

Next, the device use rights manager 18 notifies the portable terminal 20A of acceptance of the reservation made for a device use right (step S303). When the portable terminal 20A has received the notification, the portable terminal 20A displays a message indicating the acceptance of the reservation for a device use right on the display to thereby notify User 1 of the acceptance. As the reservation for a device use right has been accepted, the reservation button on the display of the portable terminal 20A enters the non-selectable state, as illustrated in FIG. 6C, for example.

The device use rights manager 18 refers to the logged-in user list and notifies the portable terminals 20 operated by logged-in users other the portable terminal 20A and the portable terminal 20B, of the reservation status of a device use right (step S304). The reservation status is information registered in the reservation list and includes information regarding a user who retains a device use right, the number of users who have made reservations for a device use right, the order in which each user acquires a device use right, and so on. The portable terminal 20 that receives the reservation status then updates the reservation status, held thereby, of a device use right. By displaying the updated reservation status on the display of the portable terminal 20, each user who has made a reservation for a device use right is notified of the reservation status of a device use right.

In the procedure illustrated in FIG. 9, regarding the processes in steps S303 and S304, it is assumed that the process in step S303 is performed first; however, the process in step S304 may be performed first. In step S303, the device use rights manager 18 may notify the portable terminal 20A of the reservation status of a device use right as in step S304.

### Procedure for Cancelling Reservation for Device Use Right

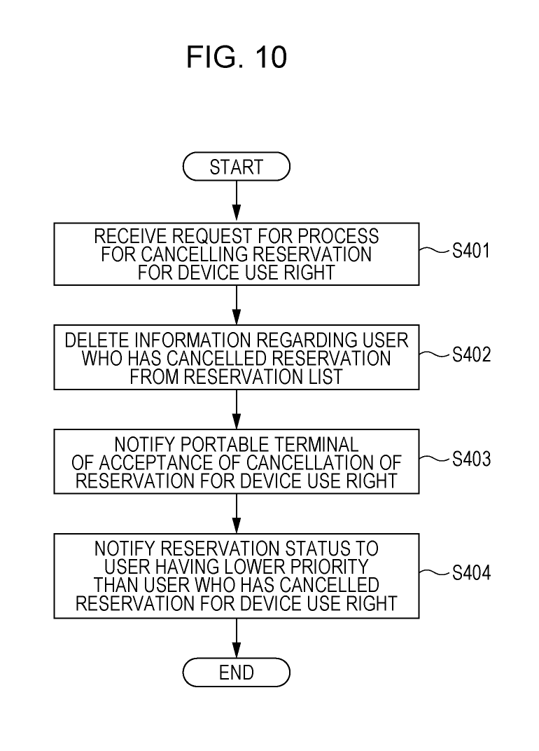

Next, a procedure for cancelling a reservation for a device use right will be described. FIG. 10 is a flowchart illustrating an example of a procedure in which the image processing apparatus 10 cancels a reservation for a device use right. In the procedure illustrated in FIG. 10, it is assumed that a user (the user having the user ID “User 1”, simply referred to as “User 1” in the description of the example illustrated in FIG. 10) performs an operation for cancelling a reservation for a device use right by using the portable terminal 20A. It is further assumed that another user (the user having the user ID “User 2”, simply referred to as “User 2” in the description of the example illustrated in FIG. 10) has already acquired a device use right by operating the portable terminal 20B.

First, User 1 performs an operation for cancelling a reservation for a device use right on the portable terminal 20A. Here, User 1 performs an operation for selecting a button (not illustrated) for cancelling a reservation for a device use right, for example, the button being displayed on the display of the portable terminal 20A. By the operation, a request for a process for cancelling the reservation for a device use right is transmitted from the portable terminal 20A to the image processing apparatus 10. The device use rights manager 18 receives the request for a process for cancelling the reservation for a device use right (step S401). Next, the device use rights manager 18 deletes information regarding User 1 who has cancelled the reservation for a device use right from the reservation list, on the basis of the received request for a process (step S402).

Next, the device use rights manager 18 notifies the portable terminal 20A of acceptance of the cancellation of the reservation for a device use right (step S403). When the portable terminal 20A has received the notification, the portable terminal 20A displays a message indicating that the reservation for a device use right has been cancelled on the display to thereby notify User 1 of the cancellation. As the reservation for a device use right has been cancelled, the reservation button on the display of the portable terminal 20A enters the state where a selection operation may be accepted.

The device use rights manager 18 notifies the reservation status of a device use right to a user who has a lower priority of being granted a device use right than User 1 who has cancelled the reservation for a device use right, on the basis of the reservation list (step S404). More specifically, the device use rights manager 18 notifies the reservation status of a device use right to the portable terminal 20 operated by a user who has a lower priority of being granted a device use right than User 1. The portable terminal 20 that has received the reservation status then updates the reservation status, held thereby, of a device use right. By cancellation of the reservation for a device use right made by User 1, the priority levels of users having lower priorities than User 1 are respectively incremented by one.

In the procedure illustrated in FIG. 10, regarding the processes in steps S403 and S404, it is assumed that the process in step S403 is performed first; however, the process in step S404 may be performed first.

### Another Example of Procedure for Granting Device Use Right

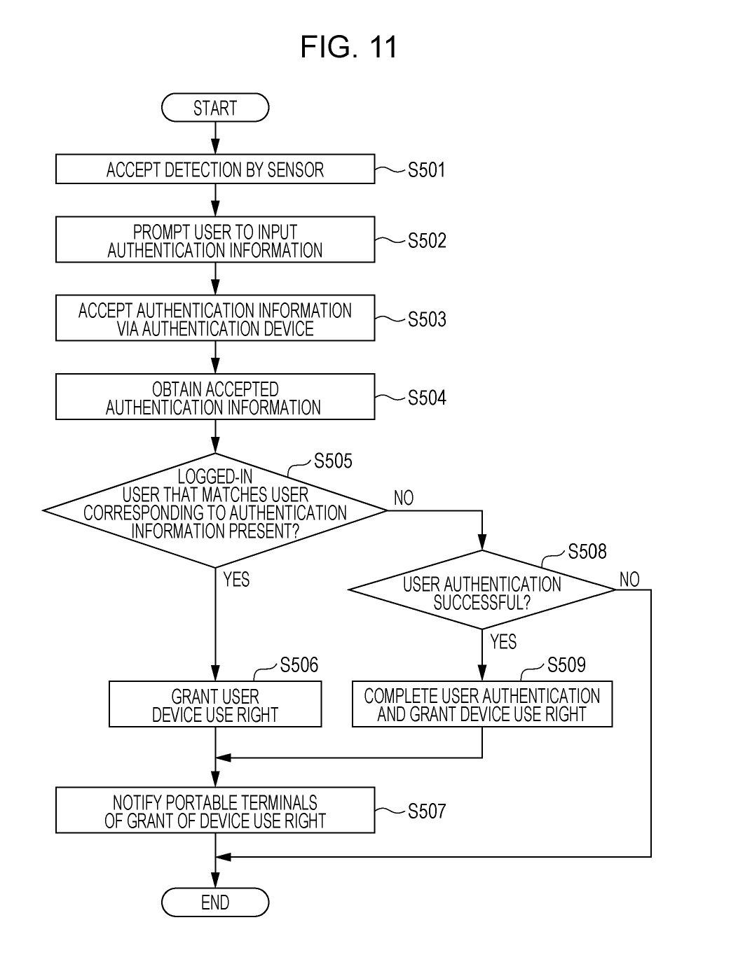

Next, another example of a procedure for granting a device use right will be described. FIG. 11 is a flowchart illustrating another example of a procedure in which the image processing apparatus 10 grants a user a device use right. In the procedure illustrated in FIG. 11, the image processing apparatus 10 detects the presence of a user in a place where the user is able to operate the image processing apparatus 10 while a device use right has not yet been granted to any user, and starts a process for granting a device use right.

Here, the image processing apparatus 10 determines whether or not a user is present in the vicinity of the image processing apparatus 10 where the user is able to operate the image processing apparatus 10, by using various sensors, for example. That is, in a case where the document sensor 120 has detected a document having been loaded, in a case where the cover sensor 121 has detected the cover having been opened, or in a case where the motion sensor 109 has detected a motion in the detection area, the image processing apparatus 10 determines that a user is present in the vicinity of the image processing apparatus 10. The image processing apparatus 10 may determine that a user is present in the vicinity of the image processing apparatus 10 in response to contact with the screen of the display 12, which is a touch panel, or in response to an input operation to the authentication device, such as the IC card reader 108, for example.

Description of the example illustrated in FIG. 11 will be given while assuming that the image processing apparatus 10 determines that a user is present in the vicinity of the image processing apparatus 10 in response to detection by the document sensor 120.

When the document sensor 120 has detected a document having been loaded in the automatic document feeder, the sensor processor 13 accepts the detection (step S501). Next, when the sensor processor 13 has accepted the detection, the user manager 17 determines that a user is present in the vicinity of the image processing apparatus 10 where the user is able to operate the image processing apparatus 10. The user manager 17 prompts the user to input authentication information (step S502). Here, the user manager 17 displays, on the display 12, a message prompting the user to input authentication information, for example.

Next, when the UI processor 11 has accepted the authentication information via the authentication device (step S503), the device use rights manager 18 obtains the authentication information accepted by the UI processor 11 (step S504). The device use rights manager 18 refers to the logged-in user list and determines whether a logged-in user that matches the user corresponding to the obtained authentication information is present (step S505).

If a logged-in user that matches the user is present (Yes in step S505), the device use rights manager 18 grants the logged-in user a device use right, that is, the user who has input the authentication information in step S503 (step S506). The subsequent process in step S507 is similar to the process in step S207 illustrated in FIG. 8, and therefore, description thereof will be omitted here.

On the other hand, if a logged-in user that matches the user is not present (No in step S505), user authentication for the user has not yet been successfully completed as in step S205 illustrated in FIG. 8. Therefore, the user manager 17 determines whether user authentication is successful as in step S208 illustrated in FIG. 8 (step S508). If user authentication is successful (Yes in step S508), the user manager 17 successfully completes user authentication, the device use rights manager 18 grants the user for whom user authentication is successful a device use right (step S509), and the process flow proceeds to step S507. On the other hand, if user authentication is not successful (No in step S508), the process flow ends.

As described above, when the image processing apparatus 10 has detected the presence of a user in the vicinity of the image processing apparatus 10 where the user is able to operate the image processing apparatus 10 while a device use right has not yet been granted to any user, the image processing apparatus 10 performs a process for prompting the user to input authentication information. When the user has input authentication information, the image processing apparatus 10 grants the user a device use right if the user is a logged-in user. Even if the user is not a logged-in user, in a case where user authentication is successful, the image processing apparatus 10 grants the user a device use right.

### Another Example of Procedure for Granting Device Use Right

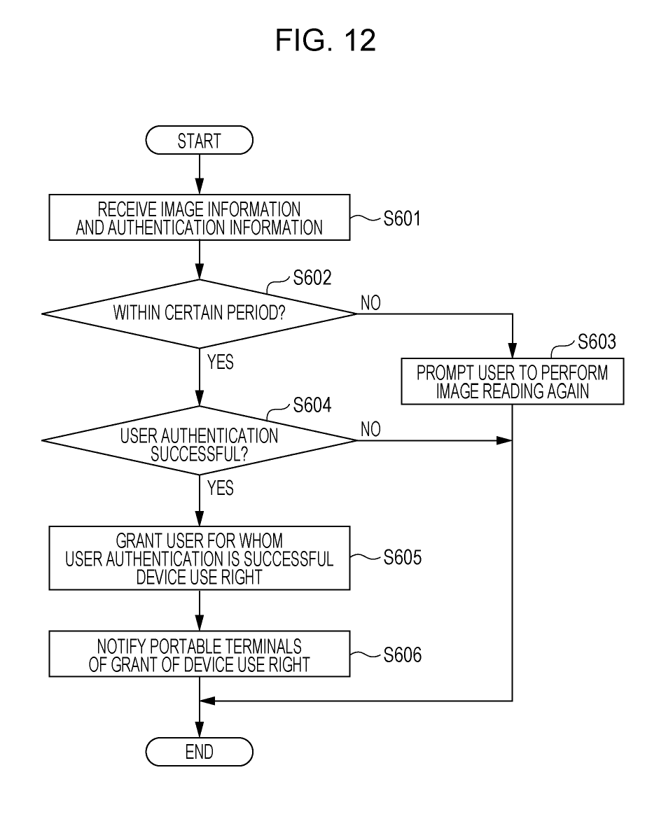

Next, yet another example of a procedure for granting a device use right will be described. FIG. 12 is a flowchart illustrating another example of a procedure in which the image processing apparatus 10 grants a user a device use right. In the procedure illustrated in FIG. 12, in a case where a device use right has not yet been granted to any user and a user has used a camera mounted on the portable terminal 20 to read an image displayed on the display 12 of the image processing apparatus 10, if information included in the image that has been read (hereinafter information included in the image is referred to as image information) is valid, the user is granted a device use right.

Specifically, in image information included in the image displayed on the display 12, a certain period is specified during which the image information is valid. A user uses the portable terminal 20 to read the image and transmits the image information included in the read image from the portable terminal 20 to the image processing apparatus 10. In a case where the image processing apparatus 10 receives the image information within the certain period specified in the image information, the image processing apparatus 10 grants the user who has transmitted the image information a device use right.

In the procedure illustrated in FIG. 12, the image processing apparatus 10 first specifies a certain period of 30 minutes from the point in time when display of the image on the display 12 starts, for example, sets the information regarding the specified certain period in the image information, and displays the image on the display 12. Next, a user activates the remote application on the portable terminal 20A, uses a camera mounted on the portable terminal 20A to read the image displayed on the display 12 of the image processing apparatus 10, and further inputs authentication information regarding the user. When the image information in the read image and the input authentication information have been transmitted from the portable terminal 20A to the image processing apparatus 10, the user manager 17 receives the image information and the authentication information (step S601).

Next, the user manager 17 determines whether or not the current time is within the certain period specified in the received image information (step S602). Here, when the user manager 17 has received the image information from the portable terminal 20A, the user manager 17 determines whether or not the current time is within the certain period specified in the image information, that is, whether or not the current time is within a period of 30 minutes from the start of display of the image, for example.

If the current time is not within the certain period (No in step S602), the user manager 17 prompts the user to perform image reading again (step S603), and the process flow ends. Here, a message prompting the user to perform image reading again is displayed on the display 12, for example. It is sufficient that the user reads an image newly displayed on the display 12, which is different from the image that has been read in step S601.

On the other hand, in step S602, if the current time is within the certain period (Yes in step S602), the user manager 17 determines whether or not user authentication is successful as in step S208 illustrated in FIG. 8 (step S604). If user authentication is successful (Yes in step S604), the user manager 17 completes user authentication, and the device use rights manager 18 grants the user for whom user authentication is successful a device use right (step S605). Next, the process flow proceeds to step S606. The process in step S606 is similar to the process in step S207 illustrated in FIG. 8, and therefore, description thereof will be omitted here. If user authentication is not successful in step S604 (No in step S604), the process flow ends.

As described above, the image processing apparatus 10 displays an image for acquiring a device use right on the display 12 in a case where a device use right has not yet been granted to any user. When the image processing apparatus 10 has received the image from the portable terminal 20 within a certain period specified in the image information, the image processing apparatus 10 grants the user who operates the portable terminal 20 a device use right. The image processing apparatus 10 grants the user a device use right in a case of receiving the image within a certain period specified in the image information, which increases the possibility of grant of a device use right while the user is present in the vicinity of the image processing apparatus 10.

In the example illustrated in FIG. 12, it is assumed that a certain period is specified in the image information. However, the example is not limited to such a configuration, and any information may be specified as the image information as long as a valid period is specified.

### Cancellation of Device Use Right and User Authentication

Next, cancellation of a device use right and user authentication will be described. First, cancellation of a device use right will be described.

After a user has acquired a device use right, the user determines a timing at which the device use right is to be cancelled. Here, as a timing at which the device use right is to be cancelled, either one of a timing when the user performs an operation for cancelling the device use right and a timing when a print process on all print jobs of the user which have accumulated in the image processing apparatus 10 is completed is selected. Hereinafter, a process in which the device use right is cancelled at the time when the user performs an operation for cancelling the device use right is referred to as immediate cancellation. A process in which the device use right is cancelled at the time when a print process on all print jobs of the user is completed is referred to as post-print cancellation.

When a user has selected a use right cancellation button (not illustrated) displayed on the display 12 and has further selected an item “immediate cancellation”, for example, a process of immediate cancellation, which cancels the device use right upon the selection, is performed. A user may select immediate cancellation in a case where the user does not need to immediately perform printing or in a case where the user desires to make another user be granted a device use right immediately, for example. By immediate cancellation, a device use right is granted to another user, and image processing by the other user is performed. Accordingly, the image processing apparatus 10 is used in accordance with the user's intention.

When a user has selected the use right cancellation button displayed on the display 12 and has further selected an item “post-print cancellation”, for example, a process of post-print cancellation, which cancels the device use right after a print process on all print jobs is completed, is performed. A user may select post-print cancellation in a case where the user desires to print all documents at once or in a case where the user does not desire a situation where his/her document is mistaken for a document of another user, for example.

Here, the use right cancellation button may be selected after a user has acquired a device use right. For example, the use right cancellation button may be selected while a print process on a print job is being performed or after a print process is completed.

The use right cancellation button may be displayed on the display of the portable terminal 20 instead of the display 12. In a case where the use right cancellation button is displayed on the display of the portable terminal 20, the portable terminal 20 notifies the image processing apparatus 10 of selection of the use right cancellation button and transmits to the image processing apparatus 10 information regarding an item selected as the timing of cancelling the device use right.

An operation for cancelling a device use right is not limited to an operation, performed by a user, of selecting the use right cancellation button and further selecting an either item of immediate cancellation and post-print cancellation. For example, as the initial configuration of the image processing apparatus 10, the image processing apparatus 10 may be configured to perform post-print cancellation. In this case, in a case where a user selects the use right cancellation button, the process of immediate cancellation is performed, for example. In a case where a user does not select the use right cancellation button, the device use right is cancelled after completion of a print process on all print jobs.

Next, cancellation of user authentication will be described. Cancellation of user authentication is a process for restoring the state of a user to a state where user authentication is not successfully completed. In cancellation of user authentication, a user selects an either one of an item of cancelling user authentication simultaneously with cancellation of the device use right and an item of cancelling the device use right but not cancelling user authentication. When a user has selected an authentication cancellation button (not illustrated) displayed on the display 12 and has further selected an item “cancellation simultaneously with cancellation of use right”, for example, the user authentication is cancelled at the time when the device use right is cancelled. In a case where a user has selected “post-print cancellation” and does not plan to perform printing thereafter, the user may choose to cancel the user authentication simultaneously with cancellation of the device use right.

When a user has selected the authentication cancellation button displayed on the display 12 and has further selected an item “cancellation separately from cancellation of use right”, for example, the device use right is cancelled but the user authentication remains without being cancelled. In a case where a user moves a way from the image processing apparatus 10 but keeps the remote application activated, or in a case where a user has given up the device use right for another user but plans to perform printing later, the user may choose to cancel the user authentication separately from cancellation of the device use right. In this case, when the user has separately performed an operation for cancelling the user authentication, the user authentication is cancelled.

The authentication cancellation button may be displayed on the display of the portable terminal 20 similarly to the use right cancellation button.

The operation for cancelling user authentication is not limited to the operation, performed by a user, of selecting the authentication cancellation button and further choosing whether or not to cancel the user authentication simultaneously with cancellation of the device use right. For example, as the initial setting of the image processing apparatus 10, the image processing apparatus 10 may be configured to cancel user authentication simultaneously with cancellation of the device use right or may be configured to cancel user authentication separately from cancellation of the device use right. Alternatively, the image processing apparatus 10 may be configured to be able to make a choice about cancellation of user authentication when a user has selected the use right cancellation button, for example.

### Procedure for Cancelling Device Use Right and User Authentication

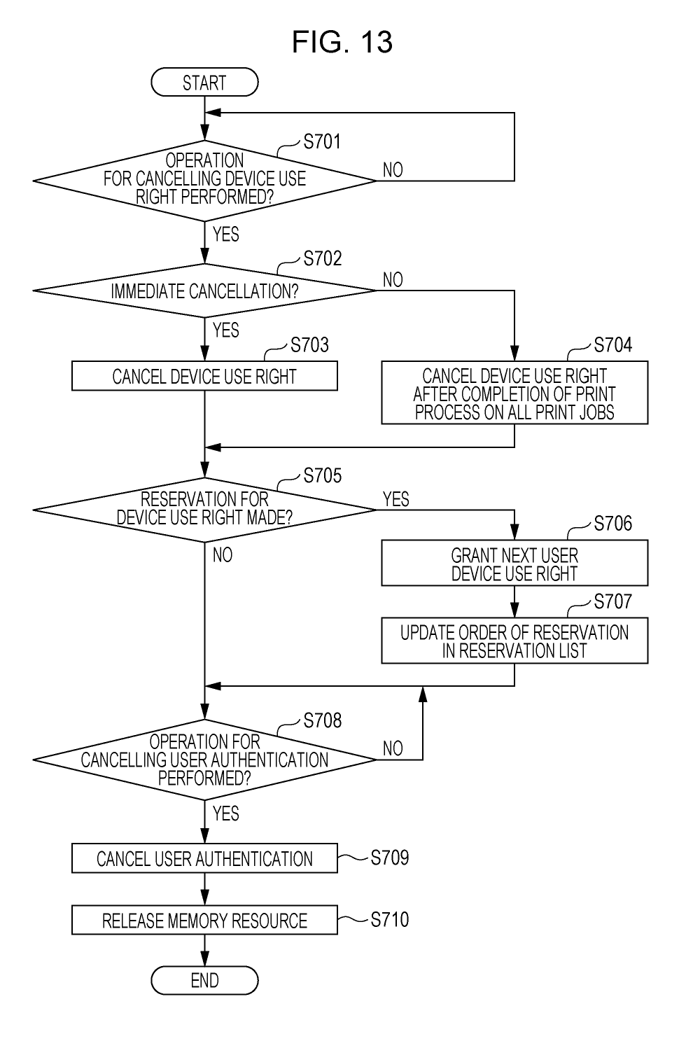

Next, a procedure for cancelling a device use right and user authentication will be described. FIG. 13 is a flowchart illustrating an example of a procedure in which the image processing apparatus 10 cancels a device use right and user authentication. In the procedure illustrated in FIG. 13, it is assumed that a user has already acquired a device use right by operating the portable terminal 20A. Description will be given while assuming that, in cancellation of a device use right, the user performs an operation for selecting the use right cancellation button and further making a selection from among the items concerned, and in cancellation of user authentication, the user performs an operation for selecting the authentication cancellation button and further making a selection from among the items concerned.

First, the device use rights manager 18 determines whether or not an operation for cancelling a device use right has been performed (step S701). Here, in a case where a device use right has been granted to a user and thereafter the use right cancellation button displayed on the display 12 has been selected, for example, the device use rights manager 18 determines that an operation for cancelling the device use right has been performed. In a case where the use right cancellation button displayed on the display of the portable terminal 20A has been selected, when the device use rights manager 18 has been notified of selection of the use right cancellation button by the portable terminal 20A, for example, the device use rights manager 18 determines that an operation for cancelling the device use right has been performed.

If an operation for cancelling the device use right has not been performed (No in step S701), the device use rights manager 18 waits for an operation for cancelling a device use right to be performed. On the other hand, if an operation for cancelling the device use right has been performed (Yes in step S701), the device use rights manager 18 determines whether or not immediate cancellation has been selected by the user (step S702). If immediate cancellation has been selected (Yes in step S702), the device use rights manager 18 cancels the device use right of the user (step S703). On the other hand, if immediate cancellation has not been selected (No in step S702), post-print cancellation has been selected by the user, and therefore, the device use rights manager 18 cancels the device use right at the time when a print process on all print jobs of the user accumulating in the image processing apparatus 10 is completed (step S704). The device use rights manager 18 thereafter notifies the portable terminal 20A of the cancellation of the device use right.

After the device use right has been cancelled in step S703 or S704, the device use rights manager 18 refers to the reservation list stored in the reservation information memory 16 and determines whether or not a reservation for a device use right has been made (step S705). If a reservation has been made (Yes in step S705), the device use rights manager 18 grants the next user in the reservation list, who is to be granted a device use right next, a device use right (step S706). Here, the device use rights manager 18 notifies the portable terminal 20 operated by the next user in the reservation list of his/her turn of being granted a device use right. When the next user has input authentication information via the authentication device in response to the notification, the device use rights manager 18 grants the next user a device use right.

Next, the device use rights manager 18 updates the order of reservation in the reservation list (step S707). The device use rights manager 18 notifies the portable terminals 20 operated by logged-in users of the grant of a device use right to the user. The device use rights manager 18 notifies the portable terminals 20 operated by users who have made reservations for a device use right of the reservation status of a device use right, on the basis of the updated reservation list.

Next, if no reservation has been made for a device use right in step S705 (No in step S705), or after the reservation list has been updated in step S707, the user manager 17 determines whether or not an operation for cancelling user authentication has been performed (step S708). Here, if the authentication cancellation button displayed on the display 12 has been selected after successful completion of user authentication and the item of cancelling user authentication simultaneously with cancellation of the device use right has been selected, for example, the user manager 17 determines that an operation for cancelling the user authentication has been performed.

If an operation for cancelling user authentication has not been performed (No in step S708), the user manager 17 waits for an operation for cancelling user authentication to be performed. In this case, the user remains in a state where user authentication has been successfully completed, and the portable terminal 20A remains in the mode in which an operation for performing presetting relating to output, an operation for transmitting a print job, and the like may be accepted. On the other hand, if an operation for cancelling user authentication has been performed (Yes in step S708), the user manager 17 cancels the user authentication (step S709). The user manager 17 notifies the portable terminal 20A of the cancellation of user authentication.

Next, the user manager 17 releases a memory resource that may be released in response to cancellation of user authentication (step S710), and the process flow ends. The release of a memory resource is a process for freeing up the memory area in the non-volatile memory 104, for example. By releasing a memory resource, the memory area that may be used in user authentication of another user is secured.

As described above, the image processing apparatus 10 performs the process of immediate cancellation of a device use right or the process of post-print cancellation of a device use right. The image processing apparatus 10 performs a process for cancelling user authentication simultaneously with cancellation of a device use right or a process for cancelling user authentication separately from cancellation of a device use right. The image processing apparatus 10 manages cancellation of a device use right separately from cancellation of user authentication. As a result, user authentication is maintained even if a device use right is cancelled, and therefore, the user does not need to input authentication information again when the user thereafter uses the image processing apparatus 10, which increases the convenience of users.

In cancellation of a device use right, in a case where a user has cancelled a print process on a print job by operating the image processing apparatus 10, for example, the device use rights manager 18 may cancel the device use right of the user. In a case where a user has cancelled user authentication by operating the image processing apparatus 10, for example, the device use rights manager 18 may cancel the device use right of the user. In a case where a user has not input authentication information via the authentication device within a predetermined time period after successful completion of user authentication, the user manager 17 may cancel the user authentication. However, there is a possibility that the user attempts printing again, and therefore, the user authentication may be maintained without being cancelled.

In a case where a trouble occurs in the image processing apparatus 10, for example, and a user restarts the image processing apparatus 10 for recovery, the authentication information list and the logged-in user list are retained even after the restart as long as the lists are stored in the non-volatile memory 104, for example. Accordingly, the image processing apparatus 10 may be configured to refer to the authentication information list or the logged-in user list after the restart, and to reestablish connections with the portable terminals 20 operated by logged-in users for whom user authentication has been successfully completed or to perform a process for granting again a device use right to a user to which a device use right has been granted before the restart. For the portable terminal 20 with which a connection is not reestablished after the restart, the image processing apparatus 10 may delete information relating to the portable terminal 20 from the authentication information list or the logged-in user list.

In a case where a user has ended the remote application on the portable terminal 20 but the device use right or the user authentication has not been cancelled for the user thereafter, the image processing apparatus 10 may perform a process for cancelling the device use right or the user authentication.

In a case where a user who has used the image processing apparatus 10 moves away from the image processing apparatus 10 and the motion sensor 109 detects the user moving away from the image processing apparatus 10, the device use rights manager 18 may cancel only the device use right while maintaining the user authentication on the condition that the remote application does not end on the portable terminal 20 operated by the user. The user is able to perform presetting for printing and the like without inputting authentication information, because the user authentication is maintained, while a device use right is granted to another user because the device use right of the user is cancelled.

As described above, the image processing apparatus 10 does not grant a user for whom user authentication is successful a device use right, and grants the user who has further input authentication information via the authentication device a device user right. In a case where the plural portable terminals 20 establish connections with the image processing apparatus 10, if a user is granted a device use right upon successful user authentication by only operating the portable terminal 20, a situation may arise where the other users who have not yet acquired a device use right are not allowed to use the image processing apparatus 10 although no user is present in the vicinity of the image processing apparatus 10. That is, a situation may arise where a user is not allowed to use the image processing apparatus 10 although the user comes in the vicinity of the image processing apparatus 10 in order to operate the image processing apparatus 10, which causes confusion in use of the image processing apparatus 10 and may decrease the convenience of users.

In this exemplary embodiment, the image processing apparatus 10 performs user authentication separately from grant of a device use right. When user authentication is successful, presetting for performing image processing, such as presetting relating to output, transmission of a print job, and the like, is performed. To the image processing apparatus 10, the plural portable terminals 20 are connected, and therefore, users for whom user authentication is successful respectively operate the portable terminals 20 and perform presetting for image processing. The image processing apparatus 10 grants a user for whom user authentication is successful a device use right when the user has input authentication information via the authentication device. Therefore, a user who is present in the vicinity of the image processing apparatus 10 is granted a device use right. Even in a case where the plural portable terminals 20 establish connections with the image processing apparatus 10, confusion in the use of the image processing apparatus 10 does not occur, and a decrease in the convenience of users is suppressed.

Note that while description of the present invention has been given with reference to the exemplary embodiment, the technical scope of the present invention is not limited the above-described exemplary embodiment. It is apparent to those skilled in the art that various modifications may be made or alternative embodiments may be employed without departing from the spirit and scope of the present invention.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a first authentication unit that obtains, from a terminal apparatus, information regarding a user who uses the image processing apparatus, and performs first authentication of the user by using the obtained information;
an accepting unit that accepts an instruction relating to image processing from the terminal apparatus in the first authentication; and
a second authentication unit that accepts information regarding the user for whom the first authentication has been successfully completed, and performs second authentication in order to permit performing of the image processing based on the instruction accepted by the accepting unit.

2. The image processing apparatus according to claim 1, wherein
the first authentication unit performs, in a case where the first authentication unit has obtained information regarding a user for whom authentication has not been successfully completed, the information having been input by an operation performed on the image processing apparatus, the first authentication by using the information regarding the user, and
the second authentication unit performs the second authentication in order to permit performing of image processing for which an instruction has been given by the user operating the image processing apparatus for whom the first authentication has been successfully completed.

3. The image processing apparatus according to claim 1, further comprising:
a reservation unit that makes, in a case where performing of the image processing has been permitted by the second authentication unit, a reservation for performing of image processing for which an instruction is given by another user operating another terminal apparatus for whom the first authentication performed by the first authentication unit has been successfully completed.

4. The image processing apparatus according to claim 2, further comprising:
a reservation unit that makes, in a case where performing of the image processing has been permitted by the second authentication unit, a reservation for performing of image processing for which an instruction is given by another user operating another terminal apparatus for whom the first authentication performed by the first authentication unit has been successfully completed.

5. The image processing apparatus according to claim 3, wherein
the reservation unit notifies, in a case where the reservation unit has made a reservation for performing of the image processing, terminal apparatuses other than the terminal apparatus that has given an instruction for performing of the image processing permitted by the second authentication unit and the other terminal apparatus that has given an instruction for performing of the image processing for which a reservation has been made by the reservation unit, of a reservation status concerning performing of image processing.

6. The image processing apparatus according to claim 4, wherein
the reservation unit notifies, in a case where the reservation unit has made a reservation for performing of the image processing, terminal apparatuses other than the terminal apparatus that has given an instruction for performing of the image processing permitted by the second authentication unit and the other terminal apparatus that has given an instruction for performing of the image processing for which a reservation has been made by the reservation unit, of a reservation status concerning performing of image processing.

7. The image processing apparatus according to claim 3, further comprising:
a display controller that displays, in a case where performing of image processing has been permitted by the second authentication unit, an operation accepting section on a display of the other terminal apparatus so as to be selectable, the operation accepting section accepting an operation for making a reservation for performing of image processing.

8. The image processing apparatus according to claim 4, further comprising:
a display controller that displays, in a case where performing of image processing has been permitted by the second authentication unit, an operation accepting section on a display of the other terminal apparatus so as to be selectable, the operation accepting section accepting an operation for making a reservation for performing of image processing.

9. The image processing apparatus according to claim 5, further comprising:
a display controller that displays, in a case where performing of image processing has been permitted by the second authentication unit, an operation accepting section on a display of the other terminal apparatus so as to be selectable, the operation accepting section accepting an operation for making a reservation for performing of image processing.

10. The image processing apparatus according to claim 6, further comprising:
a display controller that displays, in a case where performing of image processing has been permitted by the second authentication unit, an operation accepting section on a display of the other terminal apparatus so as to be selectable, the operation accepting section accepting an operation for making a reservation for performing of image processing.

11. The image processing apparatus according to claim 1, wherein
the first authentication unit performs, in a case where performing of image processing has been permitted by the second authentication unit and where the first authentication unit has obtained information regarding another user from another terminal apparatus, the first authentication of the other user by using the obtained information.

12. The image processing apparatus according to claim 1, wherein
the first authentication unit maintains the first authentication in a successful authentication state in a case where the first authentication has been successfully completed, where performing of image processing has been permitted by the second authentication unit, and where the permission has been cancelled thereafter.

13. An image processing system comprising:
an image processing apparatus that processes image data and forms an image on a recording medium; and
a terminal apparatus that communicates with the image processing apparatus,
the image processing apparatus including
a first authentication unit that obtains, from the terminal apparatus, information regarding a user who uses the image processing apparatus, and performs first authentication of the user by using the obtained information,
an accepting unit that accepts an instruction relating to image processing from the terminal apparatus in the first authentication, and
a second authentication unit that accepts information regarding the user for whom the first authentication has been successfully completed, and performs second authentication in order to permit performing of the image processing based on the instruction accepted by the accepting unit.

14. An image processing method comprising:
obtaining, from a terminal apparatus, information regarding a user who uses an image processing apparatus, and performing first authentication of the user by using the obtained information;
accepting an instruction relating to image processing from the terminal apparatus in the first authentication; and
accepting information regarding the user for whom the first authentication has been successfully completed, and performing second authentication in order to permit performing of the image processing based on the instruction.

15. A non-transitory computer readable medium storing a program causing a computer to execute a process for image processing, the process comprising:
obtaining, from a terminal apparatus, information regarding a user who uses an image processing apparatus, and performing first authentication of the user by using the obtained information;
accepting an instruction relating to image processing from the terminal apparatus in the first authentication; and
accepting information regarding the user for whom the first authentication has been successfully completed, and performing second authentication in order to permit performing of the image processing based on the instruction.
